(19) United States
(12) Patent Application Publication
(10) Pub. No.: US 2017/0050868 A1
(43) Pub. Date: Feb. 23, 2017

(54) PHOTOVOLTAIC POWERED ELECTRODIALYSIS DESALINATION SYSTEM

(71) Applicant: Cali Pomona Foundation Inc., Pomona, CA (US)

(72) Inventors: Mohamadali Sharbatmaleki, Pomona, CA (US); Michael Lepore, Rialto, CA (US); Tiffany Lai, Alhambra, CA (US); Terrence Gaines, Ontario, CA (US); Kalvin Lam, Diamond Bar, CA (US); Lucas Townsend, Oceanside, CA (US); lk-Hyoun Kim, Upland, CA (US); Natalie La, San Dimas, CA (US); Deanna Lestina, Corona, CA (US); Christine Zheng, Arcadia, CA (US); Yaocihautl Bourdon, Santa Ana, CA (US)

(73) Assignee: Cali Pomona Foundation Inc., Pomona, CA (US)

(21) Appl. No.: 15/234,739

(22) Filed: Aug. 11, 2016

Related U.S. Application Data
(60) Provisional application No. 62/207,293, filed on Aug. 19, 2015.

(51) Int. Cl. C02F 1/469; H01M 10/46; H02S 40/38; C02F 1/46

(52) U.S. Cl. CPC C02F 1/4693; C02F 1/4604; H01M 10/465; H02S 40/38; C02F 2201/46; C02F 2201/009; H01M 2220/10

(57) ABSTRACT

The present invention discloses a portable electrodialysis unit powered by photovoltaic panels for treating brackish/saline water and produce potable water for consumption. Potable water is important in water-scarce regions or circumstances, such as desert, drought, military operations, or natural disasters. The present invention provides a photovoltaic powered desalination system capable of dynamically changing salt removal rate and product water flow rate in order to fully utilize solar energy captured by the photovoltaic panels. The invention includes a direct electric current provided by one or more photovoltaic panels that charges batteries and provide an steady electric current to an electrodialysis desalinization unit and a control unit. The control unit communicates with the photovoltaic panels and electrodialysis unit, in conjunction with sensors to monitor water flow, conductivity, pressure, water elevation levels, and/or temperature, to create a closed loop feedback system. The closed feedback system allows battery charging, power regulation, and product water parameters to be controlled while maintaining efficiency.

### RELATED APPLICATION

This application claims the benefit of priority under 35 U.S.C. §119(e) to Provisional Application No. 62/207,293, filed on Aug. 19, 2015, which is incorporated by reference in its entirety.

### STATEMENT REGARDING FEDERALLY SPONSORED RESEARCH OR DEVELOPMENT

This invention described herein was made in the course of work supported by United States Department of the Interior, Bureau of Reclamation, No. R14AS00036, Desalination and Water Purification Research Program.

### INCORPORATION BY REFERENCE OF MATERIAL SUBMITTED ON A COMPACT DISC

Not Applicable.

### THE NAMES OF THE PARTIES TO A JOINT RESEARCH AGREEMENT

Not applicable.

### BACKGROUND OF THE INVENTION

The declining supply of drinking water for an ever-increasing world population is a global concern with potential major impacts on public health. Electrodialysis (ED) is an electrochemical membrane process that reduces salt concentration from salt water by a direct electric current. Electrodialysis occurs when feed water flows into the ion exchange chamber that consists of cation and anion exchange membranes positioned alternatively between two electrodes: the cathode and the anode. When an electrical force is applied to the electrodes, the cations (positively charged ions) travel toward the cathode and anions (negatively charged ions) travel toward the anode. The cations pass through the cation membrane and are held back by the anion exchange membrane. The anions pass through the anion exchange membrane and are held back by the cation exchange membrane. At the end of this process, concentrated cations and anions flow to brine the residue stream. Electrodialysis water treatment is an important field with significant benefits to the public drinking water supply. Many regions that lack freshwater have an abundance of brackish groundwater. Through the use of Photovoltaic Electrodialysis (PVED), brackish groundwater can be harnessed as a drinking water resource without leaving a carbon footprint. PVED is the process of utilizing solar energy to remove dissolved solids from brackish water. Besides water treatment, electrodialysis has industrial applications such as, purification of amino acids, salt production, and effluent treatment.

The invention relates to a PVED unit powered by photovoltaic (PV) panels for treating brackish/saline water and produce potable water for daily consumption. The invention includes a direct electric current provided by PV panels that charges batteries to provide electric current to an ED unit, one or more circulation pumps, and a control unit. The control unit communicates with the PV panels and ED unit, in conjunction with sensors to monitor water flow, conductivity, pressure, water elevation levels, and/or temperature, to create a closed loop feedback system. The water flow rate is controlled according to the amount of solar energy captured by the PV panels. The closed feedback system allows battery charging, power regulation, and product water parameters to be controlled while maintaining efficiency.

### BRIEF SUMMARY OF THE INVENTION

The viability of solar desalination systems currently in use is conducted by evaluating the cost of product water, energy efficiency of desalination, removal rate and recovery rate of water, system capacity, and power source type. For areas with sufficient solar energy available, photovoltaic powered electrodialysis (PVED) unit may be used. The present invention relates to a PVED unit with the ability to control flow rate according to the amount of captured solar energy. Moreover, the PVED unit does not require high pressure to produce fresh water as required by reverse osmosis technology.

When the control unit measures that the PVED unit is not removing a sufficient amount of salt per pass, the control unit may either increase the energy to the PVED unit or reduce the flow rate into the PVED unit. If the control unit measures a full battery, it may increase the flow rate and/or power to the PVED unit to a point where the battery starts to discharge, then decreases a small amount to utilize all of the solar energy and maintain an energy balance.

It is an objective of this invention to provide potable water in water-scarce regions or circumstances, such as drought regions, deserts, military operations, and natural disasters.

It is a further objective of this invention to provide dynamically changing salt removal rate and product water flow rate in order to frilly utilize incoming solar energy.

It is a further objective of this invention to provide an automated control system that requires minimal user input.

These and other objectives are preferably accomplished by providing an apparatus comprising of an automated control unit, a solar energy unit, and an electrodialysis unit. The automated control unit comprises a microcontroller to process data from sensors and control electric outputs as necessary. The solar energy unit comprises one or more photovoltaic panels for capturing solar energy and converting the solar energy to electricity. The electrodialysis unit comprises at least two metal electrodes, cation permeable membranes, and anion permeable membranes. These units work in tandem, utilizing varying levels of incoming solar energy to remove dissolved solids (e.g. salt) from the feed water (e.g. brackish water).

These and other aspects of this invention will become apparent to those skilled in the art after reviewing the following description of the invention.

### BRIEF DESCRIPTION OF THE SEVERAL VIEWS OF THE DRAWINGS

The above-mentioned features and objects of the present disclosure will become more apparent with reference to the following description taken in conjunction with the accompanying drawings and images wherein like reference numerals denote like elements and in which:

FIG. 1 is a schematic of one embodiment of the photovoltaic electrodialysis unit of the present invention.

FIG. 2 is a schematic of one embodiment of the automated control unit of the present invention.

FIG. 3 is a schematic that illustrates one embodiment of photovoltaic electrodialysis unit associated with an automated control unit of the present invention.

### DETAILED DESCRIPTION OF THE INVENTION

For illustrative purpose, the principles of the present invention are described by referring to an exemplary embodiment thereof. Before any embodiment of the invention is explained in detail, it should be understood that the invention is not limited in its application to the details of construction and the arrangement of components set forth in the following description or illustrated in the following drawings. The invention is capable of other embodiments and of being practiced or of being carried out in various ways. Also, it should be understood that the phraseology and terminology used herein is for the purpose of description and should not be regarded as limiting. The use of “including,” “comprising,” or “having” and variations thereof herein is meant to encompass the items listed thereafter and equivalents thereof as well as additional items.

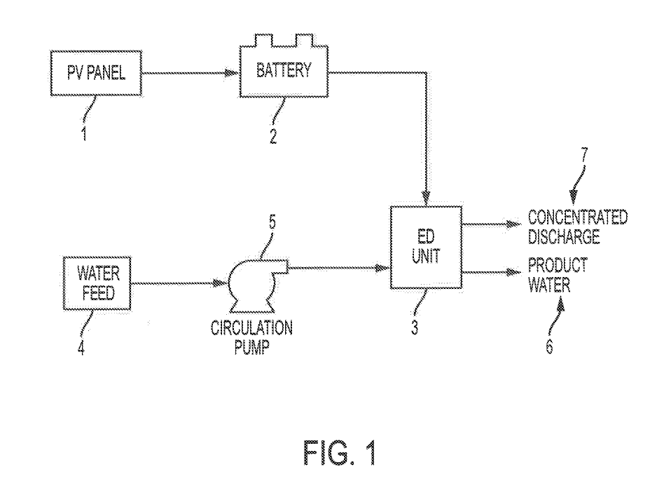

The invention relates to a photovoltaic electrodialysis (PVED) unit powered by one or more photovoltaic (PV) panels for treating brackish/saline water and produce potable water. In one embodiment, the invention includes a direct current provided by PV panels that charges one or more batteries to provide electric current to an electrodialysis (ED) unit. As shown in FIG. 1, PV panel 1 captures solar energy and converts the solar energy into electricity. The converted electricity, travels as electric current, charges a battery 2 which powers an unit 3 to desalinate feed water 4 (i.e., brackish/saline water) through electrodialysis. The feed water 4 is fed to the ED unit 3 via a circulation pump 5. Typically, the ED unit 3 comprises at least two metal electrodes, cation permeable membranes, and anion permeable membranes. When an electrical force is applied to the electrodes, the cations in the feed water (positively charged ions, such as Na⁺) in the travel toward the cathode, and the anions in the feed water (negatively charged ions, such as Cl⁻) travel toward the anode. The cations pass through the cation permeable membrane and are held back by the anion permeable membrane. The anions pass through the anion permeable membrane and are held back by the cation permeable membrane. At the end of this process, concentrated cations and anions flow to a concentrated discharge stream 7 and the desalinated product water 6 is separately collected.

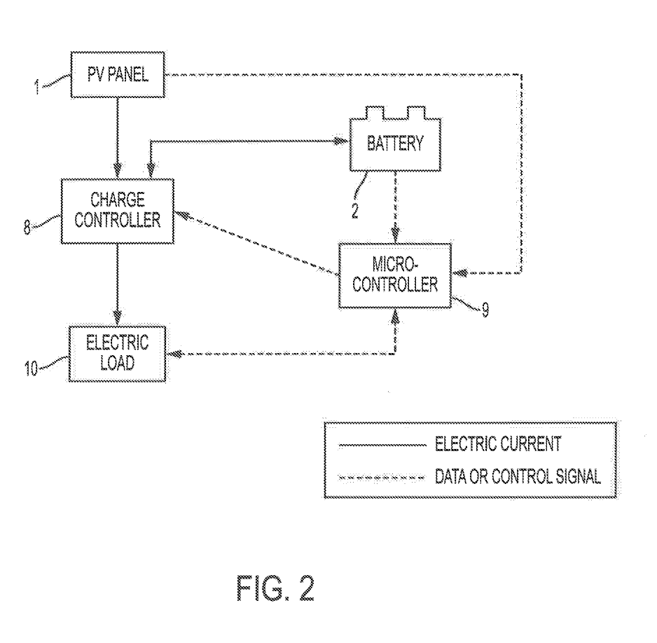

In one embodiment, the PVED unit may be controlled by an automated control unit. As shown in FIG. 2, the PV panel 1 sends the electricity converted from the captured solar energy to a charge controller 8 which is capable of regulating electric voltage and current as well as the distributing electricity to various ends, such as the battery 2 or an electric load 10. The PV panel 1 also sends data relating to the converted electricity to a micro-controller 9 which controls how the charge controller distributes the electricity received. The micro-controller 9 also receives data from the battery 2, such as the charge or discharge level of the battery, and data from the ED unit, such as the salt removal rate. Based on the data received, the micro-controller 9 determines how much of the converted electricity (such as the level or voltage and current) the charge controller would distribute to the electric load 10 (e.g., the ED unit and its power consuming peripherals) and how much converted electricity would be stored in the battery 2 for future consumption. If the converted electricity is insufficient to support the electric load 10, the battery 2 also may discharge electricity to the charge controller 8 which then distributes it to the electric load 10.

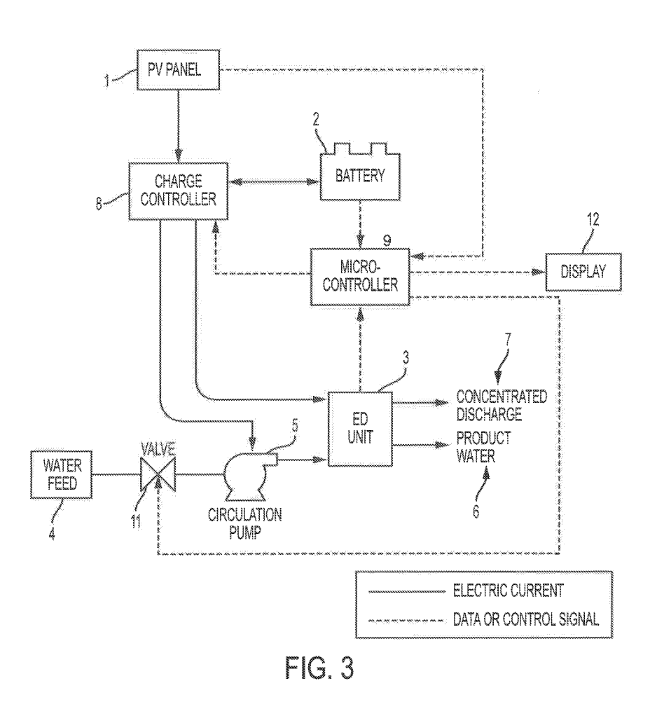

The use of an automated control unit in a PVED unit is further illustrated in FIG. 3. In a PVED unit, more electric power sent to the ED unit results in higher salt removal rate, and a higher feed water flow rate results in a lower salt removal rate. In one embodiment, the PV panel 1 sends the electricity converted from the captured solar energy to a charge controller 8 which regulates electric voltage and current as well as distributes electricity to various ends, such as the battery 2, the ED unit 3 or the circulation pump 5. The PV panel 1 also sends data relating to the converted electricity to a micro-controller 9 which controls how the charge controller distributes the electricity received. The micro-controller 9 also receives data from the battery 2, such as data representing the charge or discharge level of the battery, and data from the ED unit, such as data representing the salt removal rate. Based on the data received, the micro-controller 9 determines (via controlling the charge controller 8) how much of the converted electricity (such as the level or voltage and current) the charge controller would distribute to the ED unit 3 or the circulation pump 5 and how much converted electricity would be stored in the battery 2 for future consumption. If the converted electricity is insufficient to support the ED unit 3 and/or the circulation pump 5, the battery 2 also may discharge electricity to the charge controller 8 which then distributes it to the ED unit 3 or the circulation pump 5.

The micro-controller 9 may also control the feed water flow rate via controlling a valve 11. The micro-controller 9 may further send data to a display 12 that displays the current status of the PVED unit, such as flow rate, electric consumption, salt removal rate, water conductivity, battery charge/discharge level, etc.

As noted previously, the higher feed water flow rate results in lower salt removal rate. Therefore, if the micro-controller 9 measures that the ED unit 3 is experiencing lower salt removal rate, the micro-controller 9 may either increase the electric power to the ED unit 3 or reduce the feed water flow rate to the ED unit 3 through either controlling the pump 5 or the valve 11. If the micro-controller 9 detects that the battery 2 is fully charged, it may elect to increase the flow rate and/or the electric, power to the ED unit 3 to a point where the battery 2 starts to discharge, then decreases a small amount so as to utilize all of the solar energy and maintain an energy balance. In one embodiment, it is established that a PVED unit with automated control unit may produce product water with TDS (Total Dissolved Solid) of less than 500 mg per liter with 100 watts (12v DC) of electric power.

The previous description of the disclosed examples is provided to enable any person of ordinary skill in the art to make or use the disclosed methods and apparatus. Various modifications to these examples will be readily apparent to those skilled in the art, and the principles defined herein may be applied to other examples without departing from the spirit or scope of the disclosed method and apparatus. The described embodiments are to be considered in all respects only as illustrative and not restrictive and the scope of the invention is, therefore, indicated by the appended claims rather than by the foregoing description. All changes which come within the meaning and range of equivalency of the claims are to be embraced within their scope. Skilled artisans may implement the described functionality in varying ways for each particular application, but such implementation decisions should not be interpreted as causing a departure from the scope of the disclosed apparatus and methods. The steps of the method or algorithm may also be performed in an alternate order from those provided in the examples.

1. A photovoltaic electrodialysis apparatus for removing salt in a feed water comprising:
at least one photovoltaic panel, a charge controller, a rechargeable battery, a micro-controller, at least one circulation pump, and an electrodialysis unit;
the at least one photovoltaic panel is configured to generate and deliver a first electricity to the charge controller, a first sensor is connected to the at least one photovoltaic panel wherein the first sensor is configured to deliver a first signal to the micro-controller; the first signal comprising data representing the amount of electricity generated by the at least one photovoltaic panel;
the rechargeable battery is configured to deliver a second electricity to and receive a third electricity from the charge controller, a second sensor is connected to the rechargeable battery wherein the second sensor is configured to deliver a second signal to the micro-controller; the second signal comprising data representing the amount of electricity remains in the rechargeable battery;
the electrodialysis unit comprising an anode, a cathode, at least one cation permeable membrane, and at least one anion permeable membrane; a third senor is connected to the electrodialysis unit wherein the third sensor is configured to deliver a third signal to the micro-controller; the third signal comprising data representing the amount of salt removed from the feed water in a pre-determined temporal period;
the charge controller is configured to deliver a fourth electricity to the electrodialysis unit, a fifth electricity to the circulation pump, and the third electricity to battery;
the circulation pump is configured to receive the fifth electricity from the charge controller, receive the feed water and deliver the feed water to the electrodialysis unit; and
the micro-controller is configured to deliver a fourth signal to the charge controller wherein the fourth signal is determined based on the first, second, and third signals, and the fourth signal determines respective the electric voltage and electric current of the third electricity, the fourth electricity, and the fifth electricity.

2. A photovoltaic electrodialysis apparatus of claim 1 further comprising:
a valve configured to regulate the feed water's flow; and
a fifth signal from the micro-controller wherein the fifth signal is determined based on the first, second, and third signals; and the fifth signal controls the valve's operation.

3. A photovoltaic electrodialysis apparatus of claim 1 wherein increasing the electric voltage or electric current of the fourth electricity increases the amount of salt removed from the feed water in the pre-determined temporal period.

4. A photovoltaic electrodialysis apparatus of claim 2 wherein increasing the feed water's flow decreases the amount of salt removed from the feed water in the pre-determined temporal period.
